(19) United States
(12) Patent Application Publication
(10) Pub. No.: US 2016/0357912 A1
(43) Pub. Date: Dec. 8, 2016

(54) SYSTEM FOR UNITARY DISPLAY OF PATIENT DATA FROM MULITPLE CARE PROVIDERS

(71) Applicant: Humana Inc., Louisville, KY (US)

(72) Inventors: George Morris, Los Gatos, CA (US); Marc Willard, San Jose, CA (US)

(73) Assignee: Humana Inc., Louisville, KY (US)

(21) Appl. No.: 14/217,175

(22) Filed: Mar. 17, 2014

Related U.S. Application Data
(60) Provisional application No. 61/799,198, filed on Mar. 15, 2013.

(51) Int. Cl. G06F 19/00

(52) U.S. Cl. CPC G06F 19/322

(57) ABSTRACT

The present invention is an system and method for communicating updated patient data from a first health care provider's electronic medical records system to a second health care provider's electronic medical records system. Such a system also is configured to present data in a standardized manner and communicate changes in such data to a health analytics engine in substantially real-time.

### CROSS-REFERENCE TO RELATED APPLICATIONS

This application claims priority to provisional patent application 61/799,198, filed Mar. 15, 2013, which is hereby incorporated in by reference in its entirety.

### BACKGROUND AND SUMMARY OF THE INVENTION

Exemplary embodiments of the present invention relate generally to an apparatus for displaying patient medical data, gathered from a plurality of sources which may include recommended patient care analysis systems, and displayed in a standardized format.

Prior to electronic medical record (EMR) systems, medical records were often kept in paper format in a physician's office or hospital. Folders were maintained for each patient listing patient symptoms, diagnoses, and prescribed drugs or treatments. These paper-based records systems frequently consumed large amounts of storage space, were not easily archived and were not easily searchable. The introduction of EMR systems allowed a health care provider to gather and store patient medical records in an electronic format that was searchable, easily backed-up, and required much less space than a paper-based record system. As technology advanced, EMR systems became more commonplace in even small medical care providers. The ability to retrieve and search electronic medical records improved the ability of health care providers to provide care to their patients. However, EMR systems are not without their shortcomings. Because there are multiple providers of electronic health care record (EMR) systems, EMRs often are implemented as separate and incompatible systems between care providers. An undesirable result of such separation and incompatibility may be that patients seeking care from multiple care providers may have to repeat the same information to each care provider during an initial visit to that provider. Another undesirable result may be that these individual EMR systems may not contain all data relevant to a patient.

In addition to inconsistent records across different EMR systems, each system may have a different method and format of presenting the data recorded within that system to physicians and other health care providers. In the event that a second care provider is able to access a first care provider's EMR system, that second care provider may be faced with an unfamiliar means of presenting a patient's information or may not be able to efficiently navigate the user interface of the EMR system in order to efficiently access the information needed. For example, a patient may be diagnosed with high blood pressure at a primary care physician and fail to relate this information during a subsequent visit to a second care provider. Not realizing that the patient has been diagnosed with high blood pressure, that second provider may incorrectly interpret the patient's subsequent health complaints, resulting in less effective care or even dangerous misdiagnoses or treatment.

What is needed is a system that facilitates the display of shared information between disparate EMR systems. Such a system may display this shared patient data in a manner that presents the data in a standardized format useful to health care providers, thereby allowing a heath care provider to more readily interpret and utilize data that may have been shared by other EMR systems.

Alternatively, the display of shared information may be displayed in a customizable user interface such that the health care provider viewing the shared information may configure the display to present information in a manner most useful in providing the type of heath care provided by the viewer.

In an embodiment of the invention, the shared information may be provided to an analytics engine which performs an analysis using the shared information to generate a recommended plan of care which may be included in the display of shared information.

In addition to the novel features and advantages mentioned above, other benefits will be readily apparent from the following descriptions of the drawings and exemplary embodiments.

### BRIEF DESCRIPTION OF THE DRAWINGS

FIG. 1 is an illustration of known EMR systems;

FIG. 2 is an illustration of an embodiment of the invention showing EMR systems using computer devices to enable the generation of a unitary display;

FIG. 3 is an illustration of a computer device used in an embodiment of the invention;

FIG. 4 is an illustration of a cloud computing implementation of invention;

FIG. 5 is a flow chart of an embodiment of the invention;

FIG. 6 is an illustration of a screen shot from an embodiment of the invention; and

FIG. 7 is a flow chart of an embodiment of the invention.

### DETAILED DESCRIPTION OF EXEMPLARY EMBODIMENT(S)

In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

An apparatus for unitary display of patient data from multiple medical care providers may be created by configuration of a computerized interface device in communication with at least one other computerized interface device similarly configured. Such computerized interface devices may comprise general purpose computers; computer servers, virtual computers or computer servers created in “the cloud”, or dedicated use computerized interface devices (an “appliance”). An apparatus for unitary display of patient data from multiple medical care providers according to the present invention are applied to such computerized interface devices.

### Existing EMR Systems

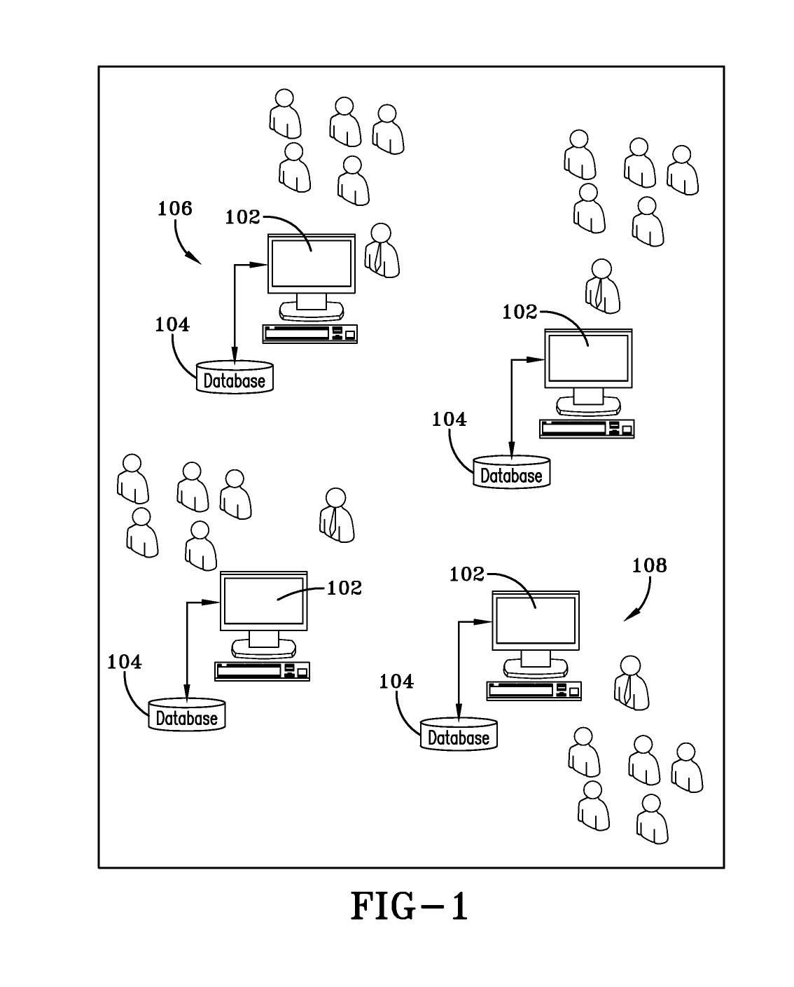

FIG. 1 illustrates a collection of known EMR systems. As illustrated, such EMR systems may be comprised of computers 102 configured to perform EMR functions and databases 104 containing patient data. Because there may be a plurality of different providers and subsequent configurations of such systems, individual EMR systems may be configured such that they do not communicate with other EMR systems. The result may be that a patient with a record on a first EMR system 106 may have a record on a second EMR system 108 that does not contain the same information as on the first system. A care provider who accesses the first EMR system may not realize that the patient has had a diagnosis from another heath care provider because that diagnosis is listed on the second but not the first EMR system.

### System of Nodes

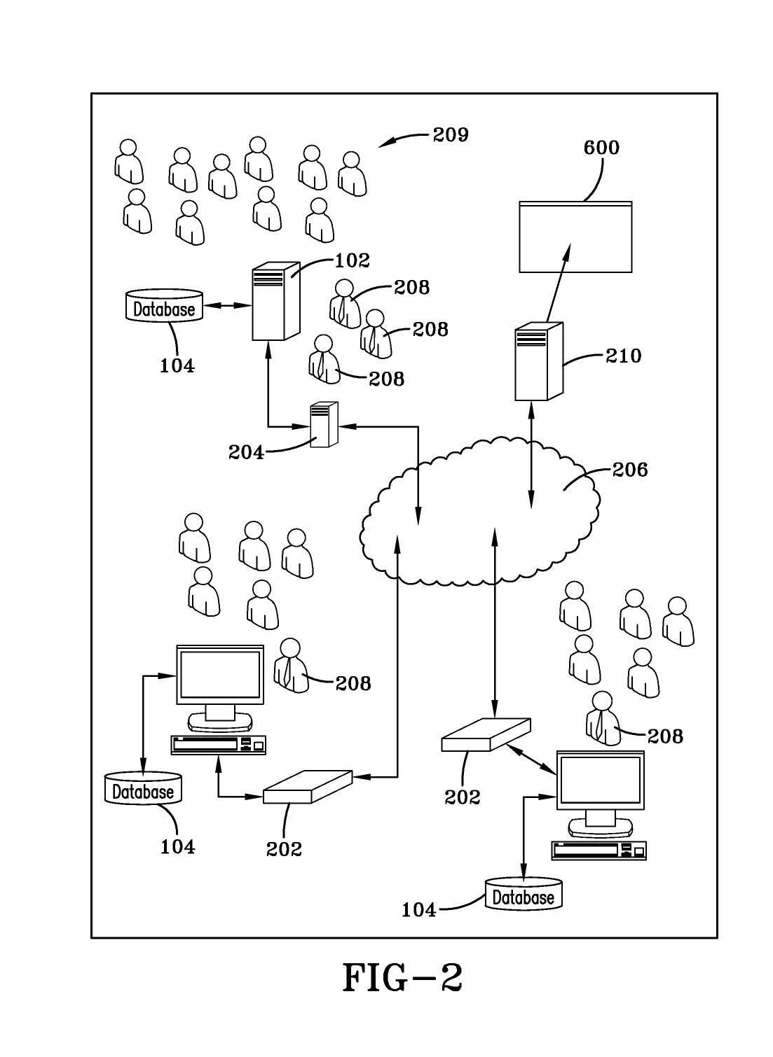

A plurality of EMR systems are currently in use in hospitals, clinics, physician's offices and other health care providers. In one legacy EMR system, patient identifier, data formats, and data storage locations most likely will be different that used in a second legacy EMR system. EMR systems may be costly to purchase and implement and data conversion from one EMR system to another may be especially costly and expose a medical care provider's data to loss or corruption. For these reasons and others, a physician or other medical care provider may be extremely reluctant to change to a new EMR system. As a result, it is unlikely that such a medical care provider will be easily convinced to change systems even to obtain the advantages of the invention described herein. A solution to such a problem is an EMR appliance. Such an EMR appliance be implemented to provide a low-cost approach to enable the sharing of EMR data from one legacy EMR system to another or as illustrated herein, to provide the interface required as part of the system of an embodiment of the invention. An EMR gateway, which is a software embodiment of an EMR appliance, may also be implemented using a software program executing on a computer device such as a computer server or other general purpose computerized hardware device. Unlike the EMR gateway, an EMR appliance is a “sealed system” that is provided in a fully functional state, with little or no setup required. As is illustrated in FIG. 2, an implement an EMR appliance or gateway may be in electronic communication with a legacy EMR system 102. An EMR appliance may be thought of as having an “EMR side” with which the legacy EMR system is in communication, and a “non-EMR side” which may be in communication with non-EMR systems, examples of which may comprise, data networks, computer servers, computers, or other EMR appliances. In an embodiment of an EMR appliance (or EMR gateway), data identifiers and storage locations from the legacy EMR system may be mapped to a unitary medical record where such data identifiers and storage locations are converted to identifiers and storage locations used in the unitary medical record. As a result, requests for data from a legacy EMR system may be mapped to a predefined common or unitary record structure as they are retrieved from the EMR system by the EMR appliance and made available to the requesting device or system.

FIG. 2 is a block diagram illustrating multiple computerized interface devices functioning as an embodiment of the invention described herein. An embodiment of a system as described herein may be comprised of at least two such computerized interface devices. Each computerized interface device may be placed in electronic communication with an EMR system, configured to retrieve and send information to and from the EMR system, and to communicate with other computerized interface devices configured to function according to embodiments of the invention. In addition to computerized interface devices in electronic communication with EMR systems, in certain embodiments of the invention, computerized interface devices may be configured to function as application portals, allowing for access to a patient's EMR data without accessing the data directly from an EMR system.

Referring to FIG. 2, a computerized interface device (such as an EMR appliance 202), may be connected to one or more additional computerized interface devices in embodiments of the invention, where each computerized interface device may be in electronic communication with an EMR system comprised of a computer 102 and electronic database 104. Such EMR systems may be configured using software from disparate providers. As is illustrated, in an embodiment of the invention a plurality of such EMR systems may be placed in electronic communication using computerized interface devices 202 configured using software to facilitate communication between EMR systems.

### Computerized Interface Device

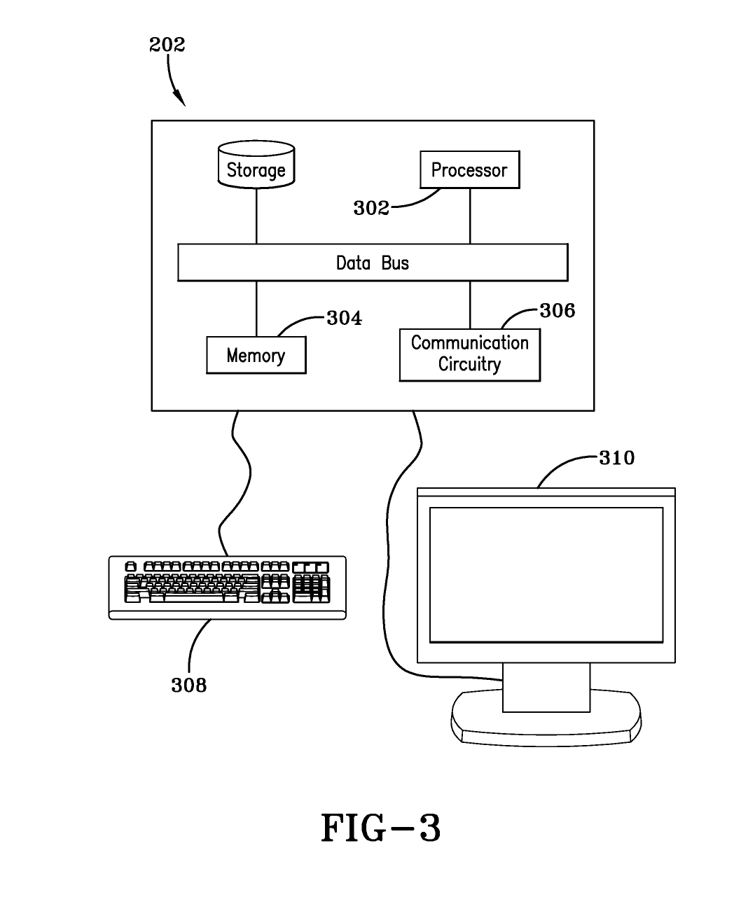

Regardless of whether a computerized interface device is configured to function as an appliance or gateway as is described herein, such a device may comprise similar components. FIG. 3 is a diagram illustrating a configuration of a computerized interface device according to an embodiment of the present invention.

Referring to FIG. 3, a computerized interface device 102 according to the present invention may comprise a processor 302, a memory 304, and communications circuitry 306 that allows the computerized interface device to communicate with a legacy EMR system and other computerized interface devices configured in an embodiment of the invention.

The processor 302 of the present computerized interface device may be configured to retrieve information from an EMR system using communications circuitry 306 that is in electronic communication with the EMR system. During such communications, the computerized interface device may retrieve patient data, arrange the data into a format that is readable by other instances of computerized interface devices configured according to the invention (“nodes”), and make that data available to the node or nodes present in an embodiment of the invention.

In embodiments of the invention computerized interface devices may also include input devices 308, such as keyboards, and output devices 310, such as computer monitors. Such input and output devices may be used to configure or otherwise interact with the computerized interface device as required.

### EMR Appliance

In smaller EMR systems, examples of which may include EMR systems that support a single medical care provider or small medical practice, embodiments of the invention may be implemented using dedicated interface devices. Such computerized interface devices may be designed such that they have limited or no user configurability in order to increase security, decrease maintenance costs, or both. A dedicated device, in contrast to a general purpose computer, may be designed as a closed system requiring minimal information technology support beyond initial configuration. Input and output devices may not be present in the case of dedicated devices; limited configuration may be performed using an interface which may be a terminal console or web-based user interface. Dedicated devices may be less susceptible to security threats than general purpose computers because of their limited configurability and non-standard operating systems. Because of their limited configurability, and minimal support requirements, dedicated interface devices are often referred to as appliances.

### EMR Gateway

EMR gateway servers may be general purpose computers configured to perform the interface functions between EMR systems and other computerized interface devices configured to collectively form embodiments of the invention. In certain embodiments of the invention, gateway servers are placed in electronic communication with larger EMR systems. EMR gateway servers may offer greater flexibility than devices with less configurability such as EMR appliances described herein and as such may offer better performance with larger EMR systems than may be achieved using less configurable EMR appliance devices. Examples of larger EMR systems may be those systems implemented by hospitals, surgery centers, or large medical care practices where there are multiple care providers accessing medical records. An example is illustrated in FIG. 2. The EMR gateway server 204 is in electronic communication with an EMR system comprised of a database 104 and computer 102. As is illustrated, the EMR system in electronic communication with the EMR gateway 204 may support a larger number of medical care providers 208 and patients 209 than those EMR systems in electronic communication with EMR appliances 202.

### Cloud Based EMR Embodiments

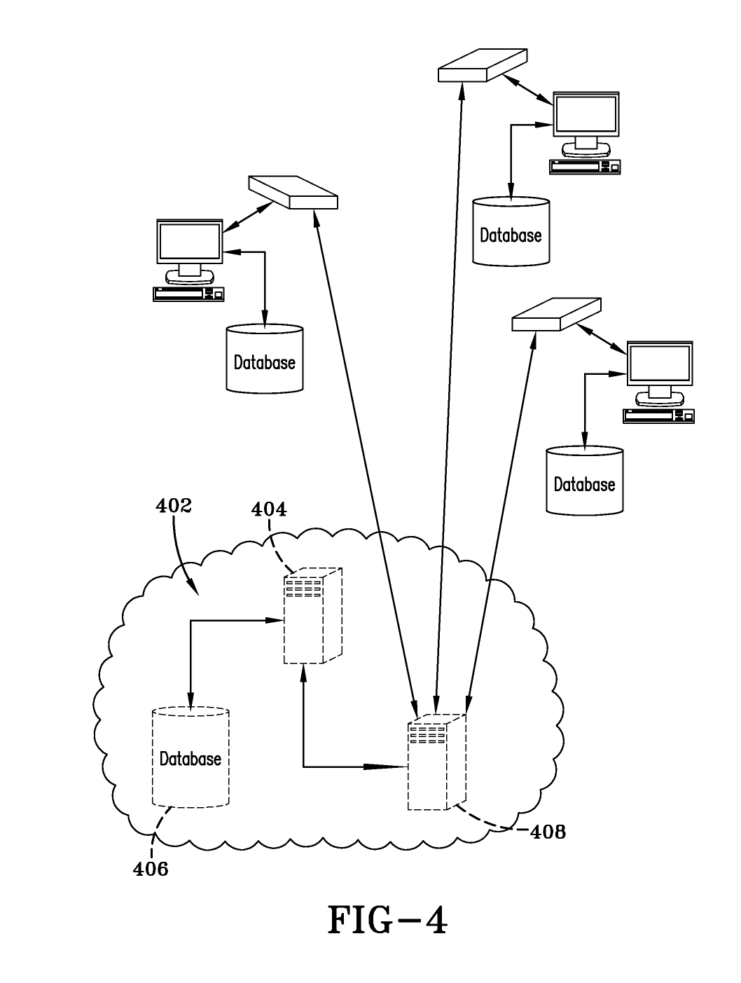

In addition to being implemented using computers 102 and databases 104 as illustrated in FIGS. 1 and 2, EMR systems may also be implemented using cloud computing techniques. In such implementations, databases and computers may be constructed from virtual computers located in remote data center facilities. In cloud computing-based embodiments, the interface devices may also be implemented using virtual computers. FIG. 4 illustrates such an embodiment where an EMR system 402 is formed in the cloud. In such an implementation, a virtual computer 404 may be formed to execute EMR system software. This virtual computer may be configured to access a cloud based database 406 containing the patient medical records data. To provide an interface in such a configuration, an embodiment of the invention may utilize a virtual EMR gateway 408. Such a virtual gateway may be formed from a virtual computer using software which configures the virtual computer to act as a virtual embodiment of the invention.

Referring to FIG. 2, a plurality of computerized interface devices 202 configured as appliances, and gateways 204 may be connected through a computer network 206 to allow the appliances and gateways to communicate with each other and share data that is contained in the various EMR systems with which the appliances and gateways are in communication. When a user 208 seeks information about a patient whose medical information is stored on a local EMR system, that user may utilize a user interface to identify the patient and view the information. In an embodiment of the invention, the computerized interface device may be configured to retrieve patient data from other nodes of the invention. These other nodes may be formed from EMR appliances and EMR gateways in electronic communication with various EMR systems.

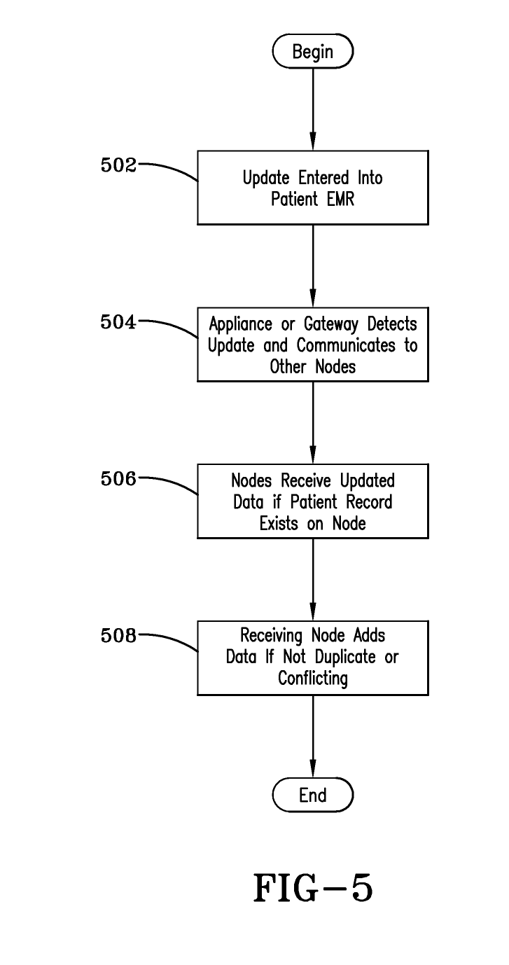

When a patient's data is updated in an EMR system connected to an embodiment of the invention, that node may be configured to automatically communicate the update to other nodes of the invention when the EMR system associated with those nodes has a record corresponding to that patient. For example, a patient record has a unique patient identifier (perhaps the patient's social security number, or other unique identifier) such that when the patients EMR is updated in one location by a care provider, all other care providers on the same network would have their EMR records for the same patient updated automatically. Those nodes may then cause the updated information to be stored in the EMR system associated with each node. In this manner, any medical care provider using one of the EMR systems in the network may have access to consistent and updated patient data. FIG. 5 illustrates a flow chart of an embodiment of this update process. In step 502, an update to a patient record is entered into an EMR. In step 504, the appliance or gateway associated with the EMR detects the updated record (for example, in batch processing each night) and communicates the update to other nodes. Each node which has a record corresponding to the patient receives the update in step 506. The receiving node may then compare the existing patient record with the updated information to make sure that the update doesn't already exist or conflict with existing patient information contained within the EMR system. If the update doesn't exist or conflict, the information is added to the patient record in step 508.

### Non EMR Nodes (Data In Place)

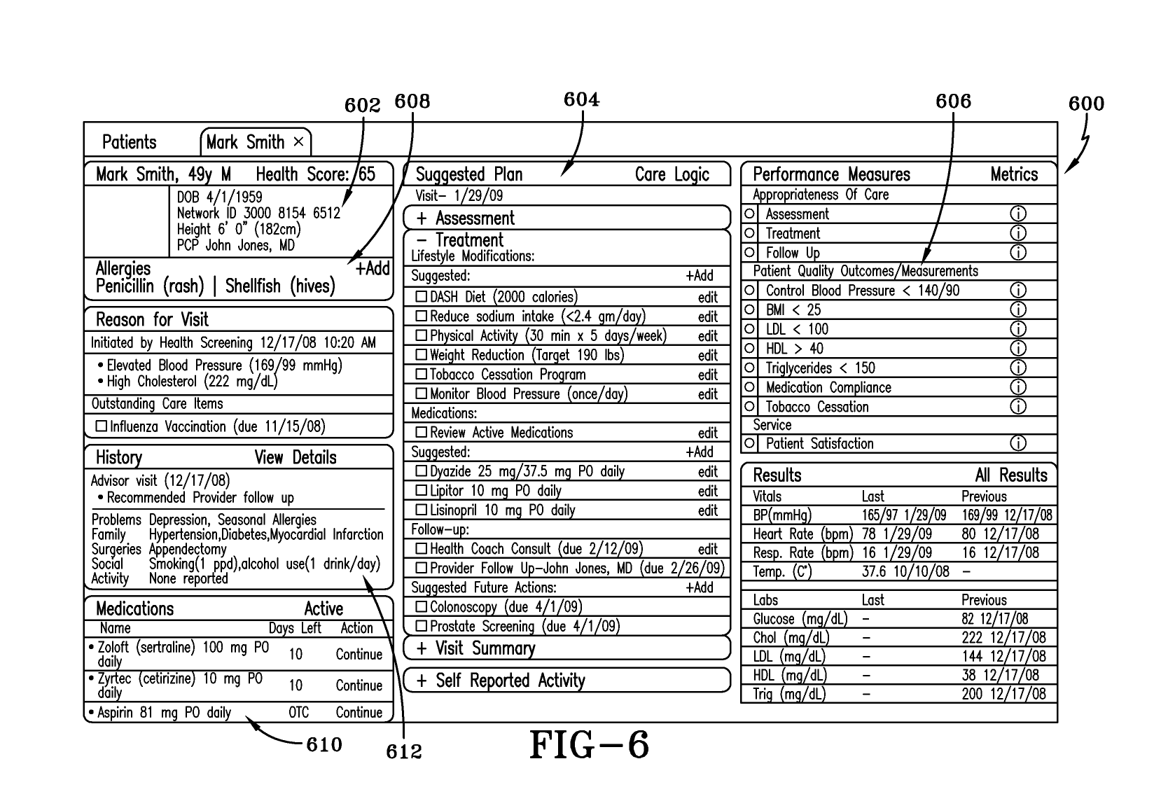

A patient may receive care from medical care providers who do not maintain an EMR system. Examples of such providers may be school nurses, company nurses, team physicians, etc. These providers may diagnose and provide care to a patient in a similar manner to those medical care providers with EMR systems. In an embodiment of the invention, a user may access an application portal (for example, accessible via the Internet) to view patient data. FIG. 6 illustrates an exemplary embodiment of a screen display of such an application portal 600. An embodiment of the invention allows providers without EMR capability to enter information into a medical record using such an application portal. The entered information may be treated by an embodiment of the invention as if it were new information entered into an EMR system connected to an EMR appliance or EMR gateway. As was illustrated in the flow chart of FIG. 5, the information may be identified as new information and distributed to EMR systems with existing records for the treated patient. To facilitate access to patient medical records for medical care providers who do not have direct access to an EMR system, a virtual application portal may be formed using a computerized interface device configured to act as a web page server. Referring to FIG. 2, a computerized interface device 210 which may not be required to be in electronic communication with an EMR system is configured to host a web page displaying an application portal 600. Such a web page may be accessed using a computer network 206, such as the internet.

### Unitary Display

As was described herein, in certain embodiments of the invention patient data in an EMR system may be updated to reflect new patient information found in other EMR systems. The result may be patient information that a viewer of an EMR system would not normally expect to see in their EMR system. Despite the fact that this information might not have existed in the EMR prior to the implementation of an embodiment of the present invention, the information may nevertheless be beneficial to the viewer for use in the detection and diagnosis of illnesses or other patient health conditions.

In order to enable the most effective use of this data, a user interface may be configured to provide a single standard display interface across each instance of an EMR gateway, EMR appliance, or application portal connected EMR system. Referring to FIG. 6, such an interface may comprise information such as patient overview data 602, suggested patient care plans 604, patient quality outcomes 606, allergy information 608, medications 610, and summary information related to visits to care providers and care provided 612. Such a uniform display replaces the need for the provider to review multiple EMRs for the same patient.

Embodiments of the invention allow users to customize the interface to enhance the user's ability to provide medical care to patients. An example of such a customization may be a section highlighting patient characteristics, allergies, and medications such that a pharmacist accessing the interface may more readily determine if a prescribed medication conforms to current guidelines and dosage amounts.

Embodiments of the invention may be configured to make it more likely that a user will be aware of critical patient data by presenting that data in a section of the user interface that is centrally located, highlighted, or otherwise set off from the remaining patient data. Certain embodiments of the invention may present this patient data in a consistent location and manner despite user customization of the remaining sections of the user interface.

### Plan of Care and Near Real-Time Bi-Directional Communication

Known EMR systems may be configured to suggest treatment plans based on patient symptoms, records of prior care provided, and patient characteristics. As with many predictive care systems, larger amounts of patient information available for analysis may produce more accurate suggestions for care than the limited patient information available on a single EMR system. Insurance providers frequently maintain databases of their member's medical claims. These medical claims may contain health diagnoses, care provided, prescriptions filled, and follow-up care sought for members. In addition, health insurance these medical claims databases contain much greater numbers of member records than a single EMR system, providing an excellent data source from which to determine what care approaches have worked for a given diagnoses.

Health analytics engines are algorithms which analyze patient data by comparing that data to the aggregated data from a large number of patients and recommended care regimens to assist in the diagnoses of illness, disease, and other health conditions and to identify a recommended course of treatment. By accessing medical claims databases and claims data, a health analytics engine may be able to more accurately predict patient outcomes and provide recommended care based on those predictions. Therefore, analysis of such database information may allow for more accurate suggested treatment plans.

Known systems of analyzing insurance claim data require that claims be submitted by a member or care provider after the member has received care from a medical care provider. This submission process frequently required periods of time ranging from 30-90 days before claims were received by an insurance provider and entered into the member claims database. Under the present invention, patient data can be analyzed with respect to similar patient experiences in the health insurance database to provide a suggested treatment approach via a computer network and preferably through the EMR.

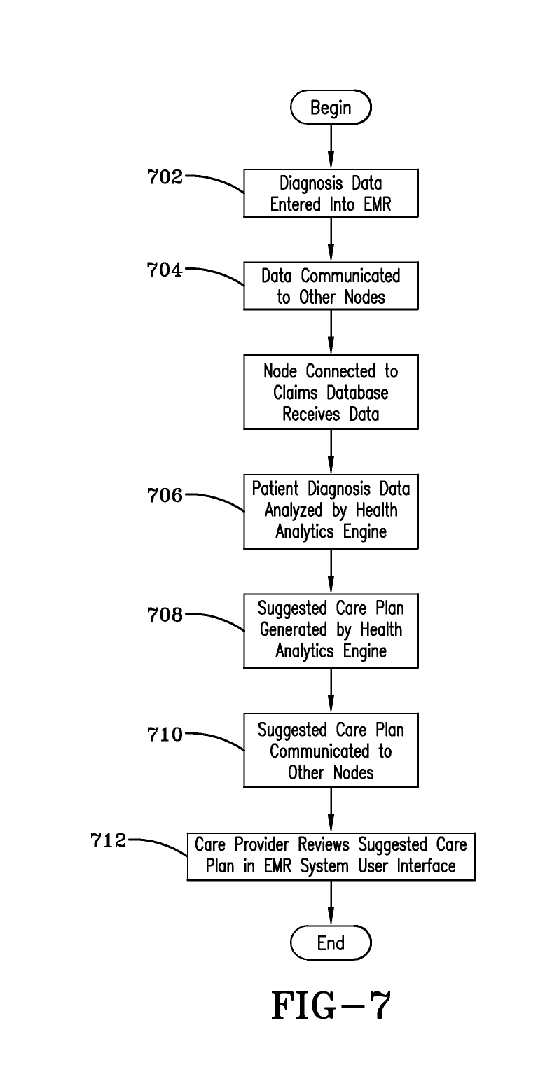

In embodiments of the current invention, patient information including diagnosis and treatment recommendations entered into an EMR system by a care provider may be communicated to the claims database of an insurance provider in a substantially real-time manner using the methods illustrated in the flow chart of FIG. 7. In step 702, a health care provider may enter patient symptoms and a diagnosis into an EMR system. The computerized interface device forming a node of an embodiment of the current invention may then communicate the updated patient information to a second node of the invention 704, where, instead of an EMR system, the second node may be in electronic communication with an insurance provider's claims database. The patient diagnosis and treatment information may then be processed by a health analytics engine 706 and a suggested care plan generated based on the analysis performed by the health analytics engine 708. The suggested care plan may be transmitted by the second node to other nodes of an embodiment of the invention 710 such that the suggested care plan may be displayed in EMR system user interfaces when the patient's EMR data is accessed by care providers 712.

Because the data is transmitted from a first EMR system to a claims database when the computerized interface device detects a change in the data corresponding to a new diagnoses or patient visit, the transmitted data can be provided to a health analytics engine and analyzed as opposed to waiting for medical claims to be submitted by a physician or patient. Because the initial 30-90 day delay is avoided, the data may be available on a substantially real-time basis instead of a 30-90 day period in known methods. Health analytics engines may be configured to process data on the same day. In such a configuration, patient data may be processed and a resultant suggested care plan made available to a care provider upon processing. The result may be that instead of a 30-90 day delay, suggested care plan information may be available to a care provider soon after patient data is entered into an EMR system.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A system for displaying a unitary electronic medical record for a patient, among a plurality of medical care providers, comprising:
a dedicated first medical care provider computer subsystem adapted to be initially configured to receive first medical data about a patient, and adapted to be secure from configuration by said first medical care provider thereafter;
a second medical care provider computer subsystem configured to receive second medical data about said patient;
at least the first and second subsystems comprising a computerized interface device which is in communication with an electronic medical record system, said computerized interface device comprising a processor, software, and a memory;
a unitary electronic medical record for said patient, which is in electronic communication with said first and second subsystems, and configured to receive said first medical data and said second medical data and automatically populate said unitary record from said first and said second medical data for said patient;
said unitary record electronically accessible by said first and said second care provider subsystems to display for said plurality of care providers medical data about said patient from said plurality of providers;
the subsystem of said first medical care provider being configured to receive electronic medical records information from said unitary record and synchronize this information to an electronic medical record in communication with said first care provider subsystem; and
the subsystem of said second medical care provider being configured to receive electronic medical records information from said unitary record and synchronize this information to an electronic medical record in communication with said second care provider subsystem.

2. (canceled)

3. The system of claim 2, wherein the at least one subsystem is an electronic medical record gateway server which is comprised of a computer server configured using software to form an interface to receive patient medical data and map said data to storage locations in a unitary electronic medical record.

4. (canceled)

5. (canceled)

6. The system of claim 2, wherein the computerized interface device in electronic communication with the electronic medical records system is configured to generate a user interface in a predetermined format specific to the needs of a viewer that contains a summary of a patient's electronic medical records.

7. (canceled)

8. The system of claim 1, wherein the system also comprises at least one computerized system interface device(s) in electronic communication with said unitary record but not in direct communication with a provider subsystem.

9. The system of claim 8, wherein the at least one computerized system interface device(s) are configured using software to send electronic medical records to and receive electronic medical records from said unitary record.

10. The system of claim 8, wherein the at least one computerized system interface device(s) are configured to display a virtual application portal on a web page wherein the virtual application portal may be configured by an algorithm contained in software to generate a user interface in a predetermined format specific to a practice requirement of a medical care provider that contains a summary of a patient's electronic medical records arranged according to the requirements of such practice.

11. (canceled)

12. The system of claim 10, wherein the virtual application portal highlights certain patient health information in the user interface where the identity of such certain patient information may be configured according to the needs of the viewer.

13-16. (canceled)

17. A device for displaying synchronized patient data from multiple electronic medical record systems comprising:
a first computerized interface device comprising a processor, a memory, and software, said computerized interface device being dedicated and secure from user configuration;
wherein the first computerized interface device further comprises interface hardware enabling it to be placed in direct electronic communication with a first electronic medical records system;
wherein the processor of the first computerized interface device is configured by an algorithm contained in software to send electronic medical records information to at least a second computerized interface device;
wherein the processor of the first computerized interface device is configured by an algorithm contained in software to synchronize electronic medical records information between the first computerized interface device and at least a second computerized interface device;
wherein the processor of the first computerized interface device is further configured by an algorithm contained in software to generate a user interface that contains a summary of a patient's electronic medical records; and
wherein the summary is comprised of a unitary compilation of medical records information contained in electronic medical records systems that are in electronic communication with the first and second computerized interface devices.

18. The device of claim 17, wherein the processor is further configured to transform the data received from an electronic medical record system to a predetermined format.

19. The device of claim 17, wherein the summary of a patient's electronic medical records is accessible through a virtual application portal on a web page.

20. The device of claim 17, wherein the second computerized interface device is an electronic medical record gateway server.
